(19) United States
(12) Patent Application Publication
(10) Pub. No.: US 2002/0094231 A1
(43) Pub. Date: Jul. 18, 2002

(54) Connecting device for connecting a mirror support and a mirror body

(76) Inventor: David Lee, Taipei (TW)

Correspondence Address: DAVID LEE, P. O. Box 24-108, Taipei, TW

(21) Appl. No.: 09/756,053

(22) Filed: Jan. 8, 2001

(51) Int. Cl. F16B 7/10

(52) U.S. Cl. 403/166

(57) ABSTRACT

An improved connecting device for connecting a mirror support and a mirror body includes a hollow connecting rod member which has one end forming an outwardly projecting fixed shaft, the other end thereof having an outwardly projecting movable shaft secured thereon. The movable shaft has a compression spring disposed therein such that the movable shaft can resiliently displace. If desired, centers of the fixed and movable shafts may be provided with through holes adapted for passage of electric wires. The fixed shaft of the connecting rod member is inserted into a locking hole in either side of the mirror body, and the movable shaft is pressed so that it retracts inwardly and displaces to the circular groove of the mirror support. When the movable shaft is released, due to the biasing action of the compression spring, the movable shaft projects outwardly to abut against the inner peripheries at both sides of the mirror support. Upon adjustment of the mirror body to cause the movable shaft to align with the circular groove, the movable shaft will extend into the circular groove to thereby couple the mirror body to the mirror support in a convenient and quick manner. The invention is simple in construction to facilitate firm connection and to reduce inventory and costs.

### BACKGROUND OF THE INVENTION

(a) Field of the Invention

The present invention relates to an improved connecting device for connecting a mirror support and a mirror body, more particularly to an improvement relating to inventory, connection and appearance of the connecting device. The connecting device includes a hollow connecting rod member which has one end forming an outwardly projecting fixed shaft, the other end thereof having an outwardly projecting movable shaft secured thereon. The movable shaft has a compression spring disposed therein such that the movable shaft can resiliently displace. If desired, centers of the fixed and movable shafts may be provided with through holes adapted for passage of electric wires. The fixed shaft of the connecting rod member is inserted into a locking hole in either side of the mirror body, and the movable shaft is pressed so that it retracts inwardly and displaces to the circular groove of the mirror support. When the movable shaft is released, due to the biasing action of the compression spring, the movable shaft projects outwardly to abut against the inner peripheries at both sides of the mirror support. Upon adjustment of the mirror body to cause the movable shaft to align with the circular groove, the movable shaft will extend into the circular groove to thereby couple the mirror body to the mirror support in a convenient and quick manner. The invention is simple in construction to facilitate firm connection and to reduce inventory and costs.

(b) Description of the Prior Art

A conventional mirror is pivotally connected to a mirror support for pivotal adjustment. In general, a through hole is formed in one side of the mirror support, and a screw is locked, via a packing piece, in one side of a mirror body for pivotal connection therewith. If necessary, glue has to be applied. The screw or screw hole is exposed on the outside, which affects the appearance of the mirror. Besides, after pivotal turning of the mirror body for many times or about a large angle, the screw may become loosened. Furthermore, as there are a number of components, assembly is inconvenient, and there is the problem of inventory. There is also provided a kind of structure in which a screw is pre-locked in one side of the mirror body and then passes through a packing piece so that the screws in both sides of the mirror body fit into through holes in the sides of the mirror support. This manner of connection is laborious. Besides, if the mirror support is too rigid, connection is not easy; on the other hand, if the mirror support is not rigid enough, it may slip out.

### SUMMARY OF THE INVENTION

The primary object of the invention is to provide an improved connecting device between a mirror support and a mirror member. The improved connecting device includes a hollow connecting rod member which has one end forming an outwardly projecting fixed shaft, the other end thereof having an outwardly projecting movable shaft secured thereon. The movable shaft has a compression spring disposed therein such that the movable shaft can resiliently displace. If desired, centers of the fixed and movable shafts may be provided with through holes adapted for passage of electric wires. The fixed shaft of the connecting rod member is inserted into a locking hole in either side of the mirror body, and the movable shaft is pressed so that it retracts inwardly and displaces to the circular groove of the mirror support. When the movable shaft is released, due to the biasing action of the compression spring, the movable shaft projects outwardly to abut against the inner peripheries at both sides of the mirror support. Upon adjustment of the mirror body to cause the movable shaft to align with the circular groove, the movable shaft will extend into the circular groove to thereby couple the mirror body to the mirror support in a convenient and quick manner. Besides, after connection, the screw will not be exposed on the outside and the connection is firm.

Another object of the invention is to provide an improved connecting device between a mirror support and a mirror member, which is simple in construction to facilitate production, and reduce inventory and costs.

### BRIEF DESCRIPTION OF THE DRAWINGS

The foregoing and other features and advantages of the present invention will be more clearly understood from the following detailed description and the accompanying drawings, in which,

FIG. 1 is a perspective view of the preferred embodiment of this invention;

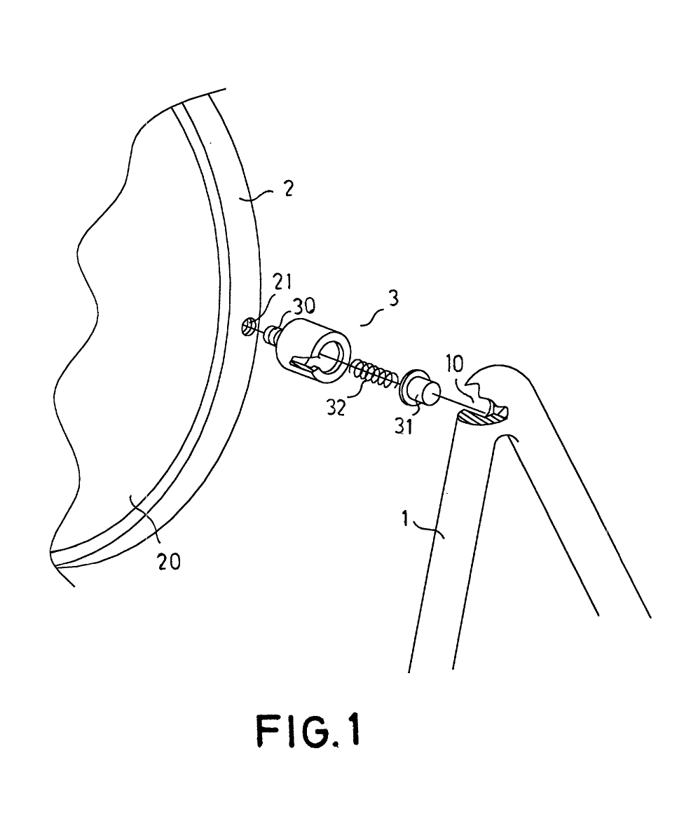

FIG. 2 is a sectional view of the preferred embodiment;

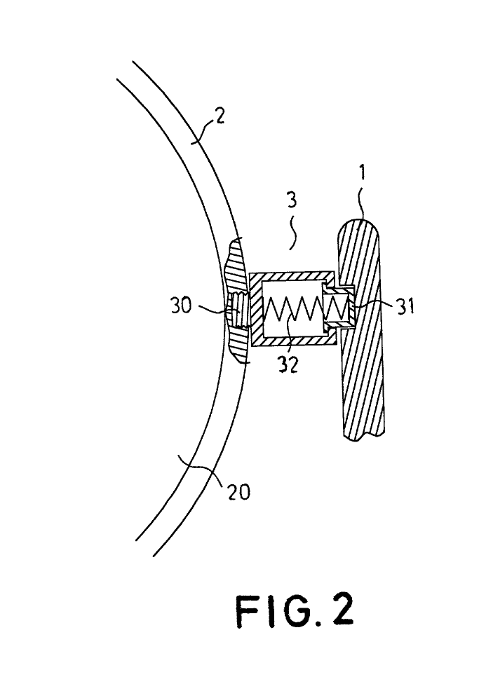

FIG. 3 is a perspective view of a modified embodiment,

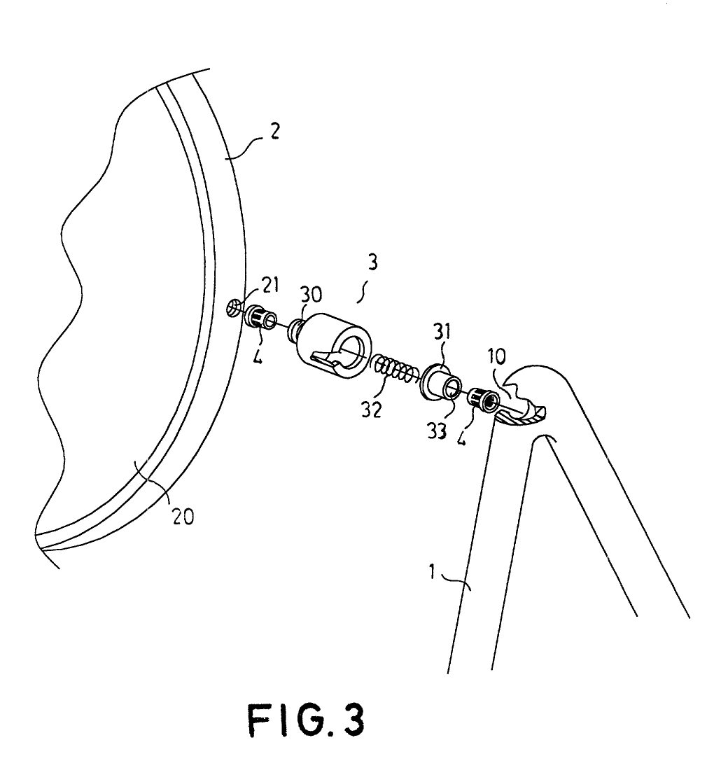

FIG. 4 is a sectional view of the modified embodiment; and

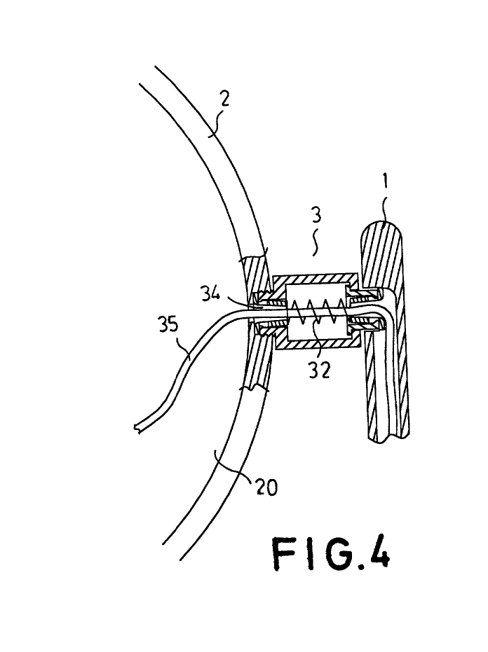

FIG. 5 is a perspective view of the conventional mirror.

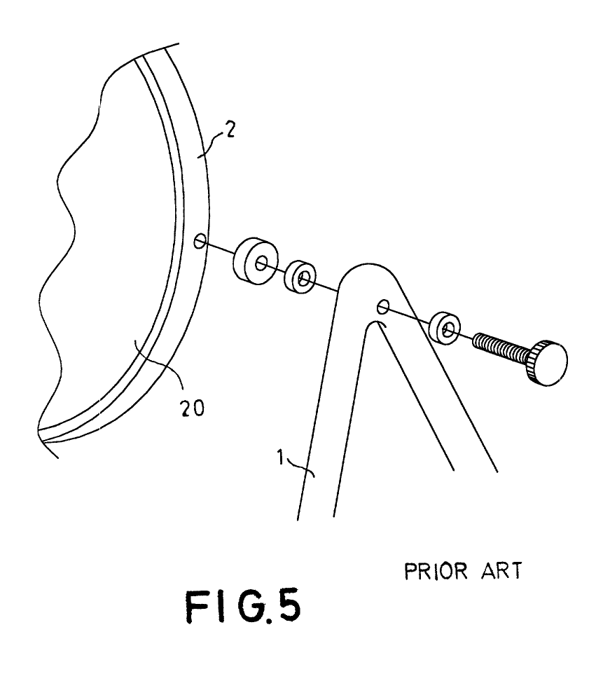

### DETAILED DESCRIPTION OF THE PREFERRED EMBODIMENT

Referring to the drawings, the present invention is shown to include a mirror support 1, a mirror body 2 and a connecting rod member 3. The mirror support 1 is disposed for supporting or suspending purposes, and has an inner wall provided with a circular groove 10 at a suitable position. The mirror body 2 is a frame member insertably provided with a mirror member 20. Both sides thereof are respectively provided with locking holes 21. The connecting rod member 3 is a hollow rod member having one end provided with an outwardly projecting fixed shaft 30. The fixed shaft 30 is sized to be able to fit into or insertably secured in the locking hole 21. The other end of the connecting rod member 3 has a movable shaft 31 projecting outwardly therefrom. The movable shaft 31 has a compression spring 32 disposed therein such that the movable shaft 31 can resiliently displace. The movable shaft 31 is sized to fit into the circular groove 10. If desired, the centers of the fixed and movable shafts 30, 31 may be provided with through holes 33, 34, respectively,, for passage of electric wires 35.

In actual use, the fixed shaft 30 of the connecting rod member 3 is inserted into the locking hole 21 in both sides of the mirror body 2 and is locked with the mirror body 2, or is extended through the locking holes 21 and locked by use of washers and nuts. The movable shaft 31 is pressed so that it retracts inwardly. The mirror body 2 is then moved to the circular groove 10 of the mirror support 1. Then, the movable shaft 31 is released so that, due to the biasing action of the compression spring 32, the movable shaft 31 projects outwardly to abut against the inner peripheries at both sides of the mirror support 1. Upon adjustment of the mirror body 2 to cause the movable shaft 31 to align with the circular groove 10, the movable shaft 31 will extend into the circular groove 10 to thereby couple the mirror body 2 to the mirror support 1. When the mirror body 2 is rotated, since the fixed shaft 30 of the connecting rod member 3 is locked in the locking hole 21 in the mirror body 2, whereas the movable shaft 31 is extended into the circular groove 10 of the mirror support 10. Hence, the connecting rod member 3 can be brought to rotate with the circular groove 10 as axis. By means of the abutting action of the movable shaft 31 and friction with the circular groove 10, the connecting rod member 3 can be temporarily secured. In addition, if the fined and movable shafts 30, 31 are provided with through holes 33, 34 for passage of electric wires 31, the outer ends thereof can be fitted with a plastic sleeve 4 to prevent damage of the electric wire 31 due to rubbing or bending.

Although the present invention has been illustrated and described with reference to the preferred embodiment thereof, it should be understood that it is in no way limited to the details of such embodiment but is capable of numerous modifications within the scope of the appended claims.

What is claimed is:

1. An improved connecting device for connecting a mirror support and a mirror body, comprising:
a mirror support being disposed for supporting or suspending purposes, and has an inner wall provided with a circular groove at a suitable position;
a mirror body being a frame member insertably provided with a mirror member, both sides thereof being respectively provided with locking holes; wherein a connecting rod member is disposed between said mirror support and said mirror body, said connecting rod member being a hollow rod member having one end provided with an outwardly projecting fixed shaft, said fixed shaft being sized to be able to fit into or insertably secured in said locking hole, the other end of said connecting rod member having a movable shaft secured thereon to project into said circular groove of said mirror support, said movable shaft having a compression spring disposed therein such that said movable shaft can resiliently displace.

2. An improved connecting device for connecting a mirror support and a mirror body of claim 1, wherein centers of said fixed and movable shafts are respectively provided with through holes adapted for passage of electric wires.
